(19) United States
(12) Patent Application Publication
(10) Pub. No.: US 2021/0219231 A1
(43) Pub. Date: Jul. 15, 2021

(54) CELL CONTROLLER AND METHOD FOR SCHEDULING DATA COMMUNICATION

(71) Applicant: MITSUBISHI ELECTRIC CORPORATION, Tokyo (JP)

(72) Inventor: Romain ROLLET, RENNES Cedex 7 (FR)

(73) Assignee: MITSUBISHI ELECTRIC CORPORATION, Tokyo (JP)

(21) Appl. No.: 16/967,499

(22) PCT Filed: Dec. 26, 2018
(86) PCT No.: PCT/JP2018/048628

§ 371 Date: Aug. 5, 2020

(30) Foreign Application Priority Data
Mar. 9, 2018 (EP) 18305255.4

(51) Int. Cl. H04W 52/02

(52) U.S. Cl. CPC H04W 52/0219; H04W 52/0216

(57) ABSTRACT

A cell controller, before sending a current beacon, calculates, for each device a maximum time offset supported by the device, taking into account the energy consumption due to go-to-sleep and wake-up phases until the moment when the device can use its timeslot. It ranks further a first list of devices intended to have a dedicated timeslot indicated in the current beacon, according to their maximum supported time offset. It picks the device at the head of the list and inserts it at the end. It calculates, for this device, a time offset t_{off,n} between a moment when the current beacon is transmitted and the moment when the dedicated timeslot is allocated and determines whether the time offset t_{off,n} of this device is greater than its maximum supported time offset. If yes, it moves the device upper in the first list, and determines a new time offset for this device.

### TECHNICAL FIELD

The present invention is related to operation optimization of communicating devices (such as connected sensors) for minimizing the power consumption of such devices.

### BACKGROUND ART

In a radio communication system, one of the main tasks of the Medium Access Control (MAC) layer is to provide channel access control mechanisms in order to share the available radio resource between the different devices (also called “stations” hereafter) that need to communicate.

In a packet-mode contention based channel access, the multiple access mechanism is able to detect and reduce data packet collisions.

On the contrary, in a circuit-switched channel access method, the multiple access mechanisms reserve some resource to establish a logical channel.

Usually, the multiple access mechanism is associated with error control mechanism used to control packet repetition in order to achieve a minimum Quality of Service (QoS) for each established channel. Optimising the global available bandwidth is also one of the main target of the multiple access mechanism. Examples of multiple access protocols that are used in packet radio wireless networks are CSMA/CA (used in 802.11 networks), Slotted ALOHA, Dynamic TDMA, Mobile Slotted Aloha, CDMA.

TDMA allows several users to share the same frequency channel by dividing the signal into different timeslots. Slots are allocated to a particular device avoiding any radio collision in the cell. A major advantage of TDMA is that the radio part of the mobile only needs to listen and broadcast for its own timeslot. Time is usually divided in fixed-duration time frames, each frame being divided into a fix number of slots. A central controller named access point, or base station in some standards, is in charge of sharing the bandwidth among the different devices that need to communicate. Some timeslots are then granted to each device, each timeslot being dedicated to the communication of the device. Usually timeslots are periodically allocated, and organised in consecutive time super-frame.

In dynamic TDMA, a scheduling algorithm dynamically reserves a variable number of timeslots in each super-frame to some variable bit-rate data streams, based on the traffic demand of each data stream. Then, the central controller order the different allocated timeslot into the super-frame in order to optimize bandwidth (reducing inter-slot times and signalling data) and the devices power consumption. To that end, signalling information is inserted at the beginning of each super-frame in order to indicate to each device the amount of allocated timeslots and their position (i.e. time offset).

In CSMA/CA, no central scheduling is required since each station decides whether it can transmit data over the channel. A Carrier Sense mechanism is used prior to transmitting to detect channel occupancy. When another station is heard, a Collision Avoidance determines the waiting period before listening again for a free communication channel. One drawback of this method is the necessity for the receiver station to listen permanently the channel, which has the high power consumption cost. For this reason, power saving algorithms have been developed to reduce power consumption. Most of them are based on the introduction of time frame of fixed duration signalled by a specific broadcast beacon frame emitted by a central controller. Only communication between the central controller and stations are allowed (i.e. infrastructure mode in 802.11). Then, stations are awoken only during some specific time frame. Central controller schedules the downlink traffic only during time frame where the destination station is awoken. However, this kind of mechanism requires the station to be awoken and to listen to the channel during one complete time frame instead of one slot in TDMA.

New hardware radio modules implement now very efficient sleeping modes that allow reducing the power consumption to several micro amperes. But putting microprocessor in active or sleeping modes still requires more power (several mA for low power devices). Considering the radio module, data reception and above all data transmission always require also more power (˜5-20 mA) for on-the-shelf integrated radio system-on-chip.

Transitions between power saving and actives modes require generally some delay because of hardware and software constraints. Then, those behaviours induce some overhead in term of power consumption and they shall be considered when designing a multiple access protocol which is not the case of existing methods.

Because of their very low power consumption, such communication modules can be coupled with energy harvesting power supply. Energy harvesting is the process that consists in collecting ambient energy (such as thermal energy, solar energy, wind energy and so on). The energy is drawn from the environment, converted and stored in a small battery or a capacitor, in order to provide energy to the microcontroller unit.

Harvesting RF energy is particularly advantageous in a communication system since it can be used to feed every wireless communication devices in a cell. Using dedicated source of RF energy allows to control the power supply of each devices. The Medium Access Control layer shall then take in charge the scheduling of burst of energy to power the wireless devices. It will depend on the multiple access protocol and the allocated radio resources.

One problem to be addressed by the invention can be defined as follows.

In a communication system dedicated to ultralow powered devices, the centralized multiple access control mechanism running in the central controller must be able to take into account not only the traffic requirement but also the energy constraints of each device in the cell in order to share the radio bandwidth. Indeed, the different wireless devices may have some heterogeneous needs because of their application requirement, their localization, and their hardware constraints.

Existing scheduling schemes used for resource sharing only consider whether a device is wake-up or sleeping. However, it can be considered a network system where the power supply of the wireless devices may use a Radio Frequency (RF) harvesting process with a dedicated RF source collocated in and controlled by the central controller to feed in power the connected devices. Then, there is a need for a centralized multiple access control mechanism that optimizes the slot allocation process and is able to schedule some bursts of energy to feed the wireless devices. This ensures the wireless network system is able to respect the traffic requirements, meaning the associated QoS of applications that run over the wireless devices.

The proposed multiple access control method based on centralized TDMA is in charge of the following tasks:
Schedule some resource timeslots for each device using well-known algorithms such as Weighted Fair Queuing, Weighted Round Robin, etc. For simple device such as sensor which needs to periodically report some measurements, a periodic and static allocation may be sufficient. In order to achieve an efficient bandwidth allocation, timeslots must be allocated only if the device has enough energy to transmit safely one or more data packets.
Evaluate the level of energy in the managed wireless devices
Optimize the order of the allocated slots within the super-frame to optimize the energy usage in the wireless devices. For devices with the most stringent energy constraints, the target is to minimize the waiting time between the beginning of the super-frame and the allocated slot position where the devices may receive or transmit data emission.
Efficiently schedule some bursts of energy taking into account energy requirements of the different communicating devices. Burst of energy are received by all devices, and are used to load device batteries. The duration of energy burst shall be minimized since they shall respect the Radio-Frequency regulation, and minimize the interference with other system running in the same frequency band.

The goal of the invention is to get a trade-off between the global bandwidth, the radio interferences, and the QoS requirements of the different wireless devices taking into account the energy constraints linked to the RF energy harvesting process that is used to power some of the wireless devices.

The invention aims to improve the situation, compared to the state of the art scheduling methods that only take traffic requirements as input.

### SUMMARY OF INVENTION

To that end, it proposes a method implemented by computer means for scheduling at least data communication in a system comprising:
communicating devices (D #0, D #1, . . . , D #n), each device having a power battery and being configured for:
   awaking in view to receive/transmit data within a predefined timeslot dedicated to said each device, and
   then going to a sleep mode so as to save battery power,
and a cell controller (CC) being configured for transmitting repetitively a beacon to the communicating devices to announce to the devices whether future timeslots are intended or not to be allocated to said devices, and eventually moments when said future timeslots are scheduled to be allocated.

More particularly, each of said devices is further configured for waking up and being active to receive the beacon, and then:
go to a sleep mode if no dedicated timeslot is available for said device before a next beacon, or
in the event when a dedicated timeslot is available for said device before a next beacon:
   stay active to use said dedicated timeslot, or
   go to a sleep mode until the moment when the dedicated timeslot is to be allocated.

It should be understood thus that the cell controller is configured for scheduling timeslots to be allocated to devices and possibly for scheduling further durations of energy bursts to provide to devices so as to load their power batteries, like presented in a particular embodiment described below.

Concerning the timeslots, the cell controller can determine the duration of the timeslots but further the time offset between the beginning of the beacon and the moment when a device can use its dedicated timeslot (i.e. the position of that timeslot in the super-frame presented above).

According to the invention, the cell controller, before sending a current beacon, is further configured for performing the following:
a) calculate, for each device intended to have a dedicated timeslot indicated in said current beacon, a maximum time offset Max(t_{off,n}) supported by the device, which takes into account the energy consumption due to go-to-sleep and wake-up phases of the device until the moment when the device can use its dedicated timeslot,
b) rank and store in a memory a first list of devices intended to have a dedicated timeslot indicated in the current beacon, according to their maximum supported time offset Max(t_{off,n}), the last device (D #n) of the list having the higher maximum supported time offset Max(t_{off,n}),
c) pick a considered device which is at the head of said first list and insert it at the end of said first list, and calculate, at least for said considered device, a time offset t_{off,n} between a moment when said current beacon is scheduled to be transmitted and the moment when the timeslot dedicated to the considered device is to be allocated,
d) determine, at least for said considered device, whether the time offset t_{off,n} is greater than the maximum supported time offset Max(t_{off,n}) of the considered device, and if yes:
   i. move said considered device (D #n) upper in the first list,
   ii. determine a new time offset t_{off,n} for said considered device, and repeat operation d) until the time offset t_{off,n} is not greater than the maximum supported time offset Max(t_{off,n}) of the considered device,
e) store in a memory a second list of devices comprising said considered device having a new list position and said new time offset t_{off,n}, and modify (i.e. update before its broadcast) said current beacon according to the second list so as to allocate at least a dedicated timeslot to said considered device at said new time offset t_{off,n}.

Therefore, thanks to that new calculation of time offset and taking into account the maximum the device can support, an optimized timeslot allocation (and in particular time offset) is performed and makes it possible to save more energy for the communicating devices.

In a particular embodiment (described below as step S7 of FIG. 4), the cell controller:
repeats operations c) and d), the second list of operation d) becoming the first list of operation c), until the second list does not comprise any device for which the time offset t_{off,n} is greater than the maximum supported time offset Max(t_{off,n}),
and updates in operation e) the current beacon according to the second list (L2) so as to allocate dedicated timeslots to said devices of the second list at respective updated time offsets t_{off,n}.

In an embodiment, the maximum supported time offset for a device is given by:

Max(t_{off,n})=(E_{0,n}−E_{sf,n}(0))/P_{A}, where:
E_{0,n} is a sensed level of available energy (or can be derived from a battery load measurement with a sensor) for the device before the start of the beacon broadcast,
E_{sf,n}(0) is an estimated level of consumed energy by the device to:
   wake up,
   receive the beacon,
   receive and/or transmit data during the dedicated timeslot, and
   go then to sleep until the next beacon,
and P_{A} is a consumed energy during active phases.

In this embodiment, the estimated level of consumed energy by the device can be given by:

E_{sf,n}(0)P_{Rx}*(T_{Beacon}+T_{Rx,n})+P_{Tx}*T_{Tx,n}+P_{A}*(T_{GS})

### Where:

P_{Rx} is the power consumption during the reception phase
P_{Tx} is the power consumption during the transmission phase
T_{Beacon} is the duration of the beacon
T_{Rx,n} is the duration of possible data reception by the device during its dedicated timeslot
T_{Tx,n} is the duration of possible data transmission by the device during its dedicated timeslot
T_{GS} is the time taken by the device to go to sleep and corresponds to a fixed duration.

Furthermore, a time T_{Dec} taken by the device to decode the beacon can be further taken into account and the estimated level of consumed energy by the device can be given by:

E_{sf,n}(0)P_{Rx}*(T_{Beacon}+T_{Rx,n})+P_{Tx}*T_{Tx,n}+P_{A}*(T_{Dec}+T_{GS})

The cell controller can be configured further to take into account, at least when allocating a new time offset t_{off,n}, an extra energy cost due to insertion of a sleeping period between the beacon broadcast and the moment when the device receives its dedicated timeslot, said extra energy cost being estimated by:

P_{A}*(T_{GS}+T_{WU}⁺T_{PreTS}−t_{off,n}) with t_{off,n}<T_{GS}+T_{WU}+T_{PreTS}, and where:
T_{WU} is a time taken by the device to wake up and corresponds to a fixed duration,
T_{PreTS} is an optional time margin taken by the device before starting to use the timeslot and corresponds to a fixed duration.

The cell controller can be configured further to calculate an estimated energy consumed by the device according to its time offset t_{off,n}:

E_{sf,n}(t_{off,n})=P_{Rx}*(T_{Beacon}+T_{Rx,n})+P_{Tx}*T_{Tx,n}+P_{A}*(T_{Dec}+T_{GS})+P_{A}*min(t_{off,n},T_{GS}+T_{WU}+T_{PreTS})=E_{sf,n}(0)+P_{A}*min(t_{off,n}T_{GS}+T_{Wu}+T_{PreTS})

with E_{sf,n}(0)=P_{Rx}*(T_{Beacon}+T_{Rx,n})+P_{Tx}*T_{Tx,n}+P_{A}*(T_{Dec}+T_{GS})

In a particular embodiment of the invention taking further into account energy burst durations to provide to devices, the cell controller is configured further to schedule energy burst transmissions to devices needing an energy battery load, and the cell controller:

* performs for said considered device of operation d):
a calculation of a first requested duration of energy burst so that the considered device is able to use the timeslot scheduled at time offset t_{off,n}, and
a determination of whether the time offset t_{off,n} is greater than the maximum supported time offset Max(t_{off,n}) of the considered device, and if yes, moving said considered device upper in the first list, and determining a new time offset t_{off,n} for said considered device, and storing in a memory the second list of devices comprising said considered device having a new list position and said new time offset t_{off,n},
   * performs for the last device of the second list:
a calculation of a second requested duration of energy burst so that said last device is able to use a timeslot scheduled at a time offset defined according to the second list,
   * and:
if the first requested duration of energy burst is higher than or equal to the second requested duration of energy burst, updates the current beacon according to the second list,
or uses the first list otherwise.

In this embodiment, the cell controller can further update the scheduled duration of energy burst to fit the power need of:
the considered device if the first list is used, or
the last device if the second list is used.

The present invention aims at a cell controller (CC) comprising a processing circuit for performing the method presented above and an example of which is shown in FIG. 5 commented below.

The present invention aims also at a computer program product, comprising instructions for performing the method as defined above, when run by a processor. A general algorithm of such a computer program can be illustrated by way of an example by the flowchart corresponding to FIG. 4 commented below.

More generally, the present invention is illustrated by way of example, and not by way of limitation, in the figures of the accompanying drawings, in which like reference numerals refer to similar elements.

### BRIEF DESCRIPTION OF DRAWINGS

FIG. 1 shows energy burst scheduling and beacons starting at successive super-frames, received on an announcement channel and indicating data scheduling.

FIG. 2 illustrates the scheme of the energy evaluation for a single device in a communicating system.

FIG. 3 illustrates the different phases (sleeping, wake up, active, go to sleep) for two devices having different respective time offsets before receiving their timeslot.

FIG. 4 shows an exemplary embodiment of successive steps of an algorithm to perform a method according to the invention.

FIG. 5 shows schematically a communication system having battery powered communicating devices and a cell controller to perform the method of the invention.

### DESCRIPTION OF EMBODIMENTS

The invention proposes a multiple access protocol implementation that is adapted to a radio communication system with ultralow powered devices.

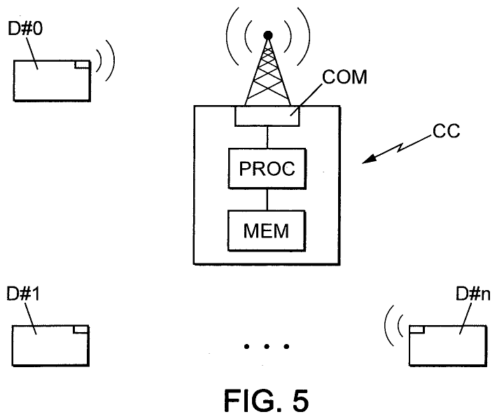

A Central Controller (labelled “CC” in FIG. 5) is in charge of sharing the radio bandwidth among wireless devices (D #0, D #1, D #n) by implementing a multiple access control method based on a centralized TDMA scheme.

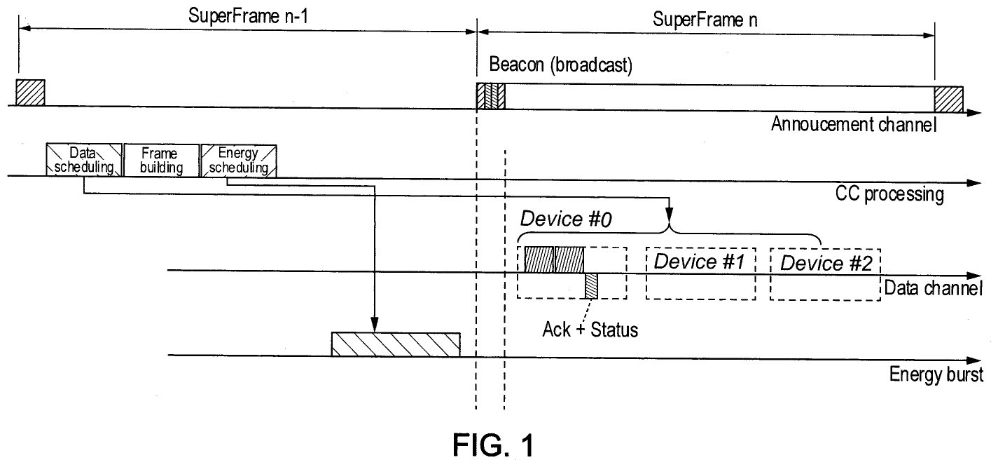

As shown in FIG. 1, time is divided in super-frames. Each super-frame starts with a broadcast beacon frame carrying information about the super-frame composition (i.e. the order, position and duration of allocated timeslots in the super-frame).

Each wireless device may have different traffic requirements and it is supposed they are able to communicate their need by using signalling data. As introduced above, before each super-frame, the cell controller CC runs scheduling algorithms to determine the amount of granted resource in the super-frame for each wake-up device.

Wireless devices also periodically report their battery/capacitor status as well as the received signal strength by using a piggybacking mechanism (signalling part). Thanks to that information, the cell controller CC is able to evaluate the evolution of the level of energy in each device.

The cell controller CC must execute the data scheduling, super-frame building and energy scheduling processes at the beginning of the preceding super-frame, so that it shall have time to potentially send some burst of energy to some requesting wireless devices.

FIG. 1 illustrates super-frames, received on an announcement channel and indicating:
Data scheduling allowing devices (here #0, #1 and #2 in the shown example) to receive/transmit data on a data channel,
Energy burst scheduling to transmit energy to any needing device.

The following relates to power consumption prediction.

To be able to efficiently predict the energy consumed by any device, the CC must know some static parameters that are dependent on the type of hardware device such as:
Time to wake
Time to go sleeping
Power consumption while:
   Sleeping
   Active
   Transmitting data
   Receiving data

Power supply of the wireless devices may use a RF harvesting process with a dedicated RF source collocated in and controlled by the central controller. Consequently, for each device, the centralized multiple access control mechanism must also have knowledge of some static parameters related to energy such as:
Power conversion efficiency ratio (which part of the available power the energy harvesting module is able to gather)

Some energy indicators are also defined to model and predict the power consumption of a device. The following parameters are permanently changing and shall be measured and reported by the device:
Received Signal Strength Indicator (RSSI) of RF energy bursts
Battery/capacitor level

The cell controller (named “CC” hereafter) controls the duration and the transmission power of energy bursts. Knowing the path loss (derived from the RSSI), and the power conversion efficiency ratio, the CC is able to calculate the amount of energy gathered by each device during the emission of an energy burst. In the reverse way, it can evaluate precisely the amount of energy the device will consume during the sleep, active, Reception (Rx) and Transmission (Tx) periods by simply multiplying the respective reference power values with the duration of these periods. After the reception of a data packet, the evaluated battery value is reset with the measured value indicated in said packet. The difference is used to calculate the error margin that is used to calculate a timeslot duration.

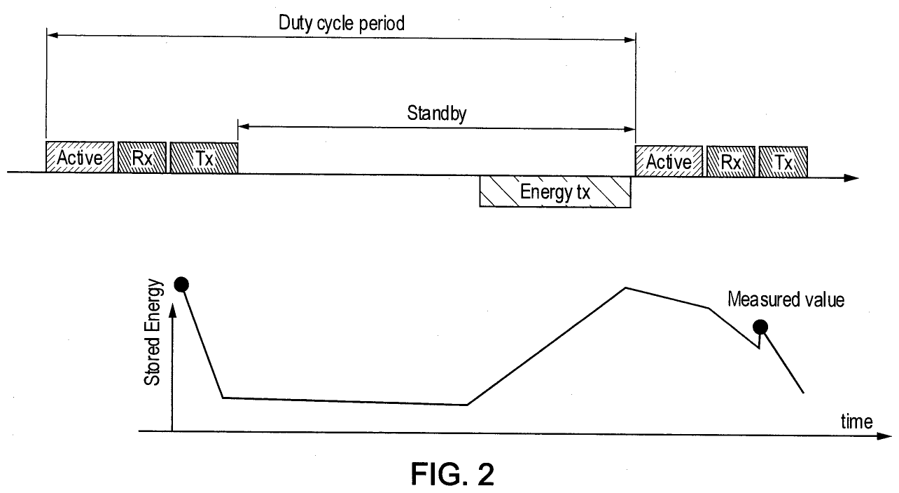

FIG. 2 illustrates the scheme of the energy evaluation for a single device. It can be observed that during the active phase (Rx, Tx) the energy of the device lowers until a standby phase having a neglectable consumption. When the device receives then the energy burst, its stored energy increases.

More particularly here, the evaluated value of the stored energy is synchronised with the measured value upon reception of a valid packet in the CC. Error in the evaluation can be due to a bad estimation of the average RSSI or the power conversion efficiency ratio.

The following is related to slot ordering and super-frame building.

At the beginning of the super-frame, the beacon frame is broadcast over an “announcement channel” to every attached device. Each awaken device shall be ready to receive it, meaning that it shall be wakeup a minimum amount of time tₚᵣₑᵣₓ before the beginning of the beacon. So, the device can be considered to be active during t_{wakeup}+tₚᵣₑᵣₓ before the reception of the beacon.

As mentioned before, the beacon contains some signalling data that can be decoded so that each active device can identify its allocated timeslot (time offset and duration) within the super frame. During this decoding phase, the device is active. Then, depending on the timeslot position, the device may either go to sleep or stay active, waiting for its dedicated timeslot. The minimum time for sleeping is equal to the sum of T_{wakeup}+T_{gotosleep}.

If the waiting time is lower than this value, then the device must stay active because it will not have enough time to go to sleep and wake up. On the contrary, knowing that the power consumption is more or less identical for the wakeup, “go to sleep” and active phases, it is preferable that a device starts a go-to-sleep procedure in order to benefit from the ultra-low power consumption of the deep sleep modes that are now available on many chipsets.

Consequently, the cell controller CC can estimate the energy overhead implied by entering/exiting the deep sleep mode.

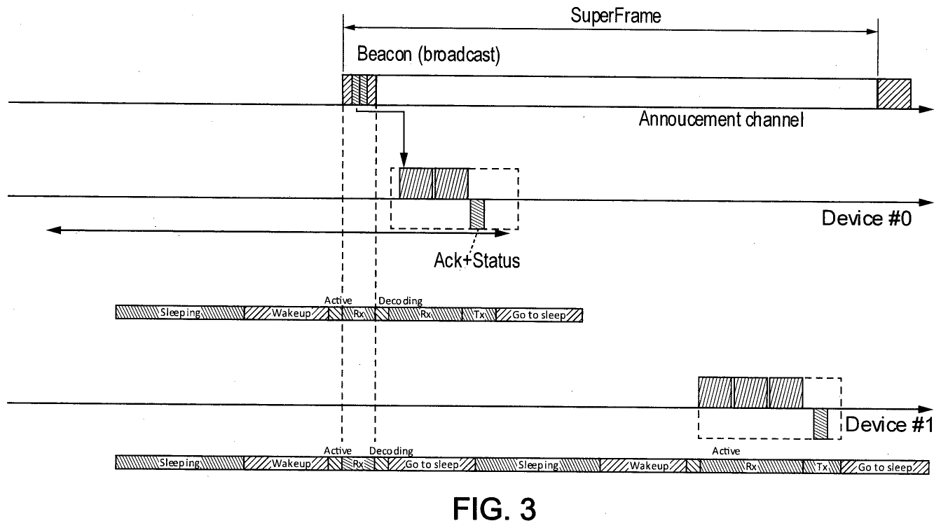

FIG. 3 illustrates the different phases for two devices. The first device #0 has its timeslot scheduled just after the beacon, while the second device #1 has enough time to go to the deep sleep mode between the end of the beacon reception and its allocated timeslot.

It must be noticed that the energy cost of the usage of a given timeslot can also be evaluated by the cell controller CC when building the structure of the next super-frame.

In order to fulfil the scheduling requirements, the goal of the super-frame building algorithm is to order the timeslots so that every device has a positive energy level after the timeslot emission.

Consequently, for each device, it is possible to calculate the maximum time offset it is able to support, this time offset being related to the sum of the go-to-sleep and wake-up phase durations. The cell controller CC can then order the scheduled devices (i.e. which have scheduled resource) in the current super-frame according to this value.

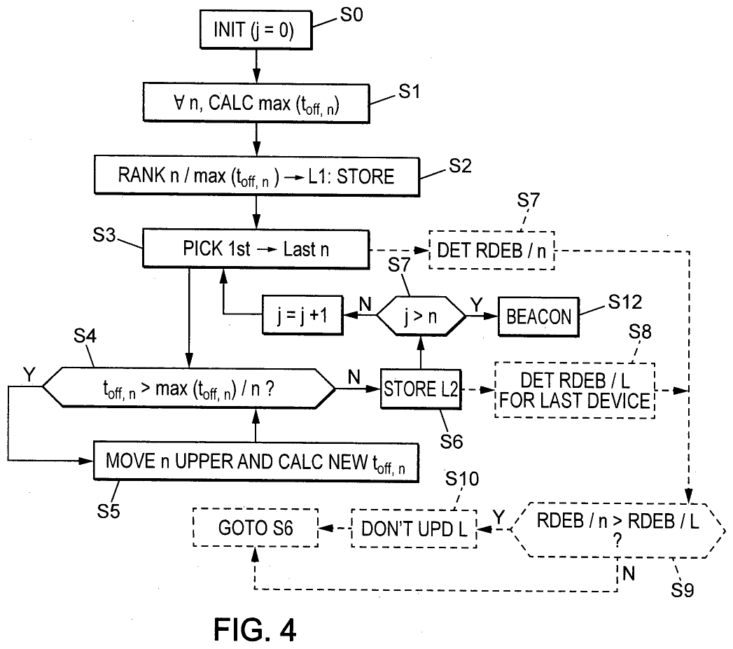

As input of the algorithm which will be described hereafter with reference to FIG. 4, the following data can be provided:
P_{A}: Power consumption during the Active phase
P_{Rx}: Power consumption during the reception phase
P_{Tx}: Power consumption during the transmission phase
T_{Beacon}: Duration of the broadcast beacon frame
t_{off,n}: Time offset between beacon and timeslot dedicated to device n
T_{Rx,n}: Duration of the reception burst of device n
T_{Tx,n}: Duration of the transmission burst of device n
T_{GS}: Go to sleep duration (fixed)
T_{WU}: Wake up duration (fixed)
T_{preTS}: Time margin before the timeslot (optional and fixed)
T_{Dec}: Time taken by a device to decode the beacon (optional and approximatively fixed)

For a device scheduled shortly after the beacon (a device having the index #0 below), the energy cost expended during one super-frame is:

E_{sf,0}=P_{Rx}*(T_{Beacon}+T_{Rx,0})+P_{Tx}*T_{Tx,0}+P_{A}*(T_{Dec}T_{GS}+t_{off,0}) with T_{Tx,0}+T_{Rx,0}<T_{TimeSlot0}

As indicated above, duration T_{Dec} is optional and can be taken into account in a sophisticated embodiment.

Furthermore, duration T_{Rx,0} is to be considered as optional as well, especially if no data is to be expected in reception for device #0. For a similar reason, if no data is to be expected in transmission for device #0, duration T_{Tx,0} can be considered as optional as well. However, it is to be noticed that if there is no data to receive/transmit for device #0, then, device #0 should be in a sleep mode.

It should be noticed further that duration T_{GS} is duly taken into account here.

For a device scheduled after a long time (a device having an index “1” in the equation given below and as illustrated in FIG. 3):

E_{sf,1}=P_{Rx}*(T_{Beacon}+T_{Rx,1})+P_{Tx}*T_{Tx,1}+P_{A}*(T_{Dec}+T_{PreTS}+2*T_{GS}+T_{WU}) with T_{Rx,1}+T_{Tx,1}<T_{TimeSlot1}

with durations T_{PreTS} and T_{Dec} optional and which can be taken into account in sophisticated embodiments.

It shall be noticed further that the sleeping power consumption is negligible compared to any other power consumption, so it is not considered in this energy calculation.

Extra energy cost due to insertion of a sleeping period is then equal to:

P_{A}*(T_{GS}+T_{WU}+T_{PreTS}−t_{off,n}) with t_{off,n}<T_{GS}+T_{WU}+T_{PreTS}.

Consequently, the energy consumed by the device n according to the time offset can be estimated to:

E_{sf,n}(t_{off,n})=P_{Rx}*(T_{Beacon}+T_{Rx,n})+P_{Tx}*T_{Tx,n}+P_{A}*(T_{Dec}+T_{GS})+P_{A}*min(t_{off,n},T_{GS}+T_{WU}+T_{PreTS})=E_{sf,n}(0)+P_{A}*min(t_{off,n},T_{GS}+T_{WU}+T_{PreTS})

with E_{sf,n}(0)=P_{Rx}*(T_{Beacon}+T_{Rx,n})+P_{Tx}*T_{Tx,n}+P_{A}*(T_{Dec} T_{GS})

Then it comes the maximum supported time offset for device #n is:

Max(t_{off,n})=(E_{0,n}−E_{sf,n}(0))/P_{A}

with E_{0,n} the estimated level of available energy for device n before the start of the super-frame.

Taking this result, the method, the steps of which are proposed in the description of FIG. 4 below, optimizes then the location of timeslots within the super-frame, so that devices with stringent energy constraints (i.e. lowest maximum time offset) have their allocated timeslots located close to the beacon frame, and are able to communicate first.

In other words, the cell controller CC shall then order the scheduled devices (i.e. which have scheduled resource) in the current super-frame according to their maximum supported time offset.

Namely, the method can be applied for devices with same or similar level of priority in order to decide the ordering of allocated timeslots within the next super-frame.

S being the set of devices to be scheduled during the super-frame, for each device of S is given the duration of the scheduled timeslot (T_{Rx,n}+T_{Tx,n}) and the maximum supported time offset Max(t_{off,n}). A classification table is defined, and empty at the beginning of the ordering process at step S0 of FIG. 4.

In step S1, the maximum supported time offset Max(t_{off,n}) is determined for each device #n aimed in a next beacon and in step S2, the devices are ranked in a list L1 according to their maximum supported time offset Max(t_{off,n}) and this list L1 is stored.

In step S3, the first device of the list L1 is picked and put at the end of the list as the last device of the list. Said in other words, the device with the lowest maximum supported time offset Max(t_{off,n}), called previously the “considered device”, is drawn from the head of the list and inserted in the classification list L1 at its end.

In step S4, the time offset t_{off,n} of that considered device is calculated and if it is greater than its maximum supported time offset Max(t_{off,n}), then it is tried to exchange this device with a previous device in the classification list L1 (moved up in the list), and the time offset for this considered device is recalculated in step S5 (and for the exchanged device as well as shown in the examples below).

As for an example hereafter, devices #4 and #3 were already inserted in the classification list.

| Device | Slot | max | |
|---|---|---|---|
| # | duration | (t_{off,n}) | t_{off,n} |
| 4 | 2 | 3 | 0 |
| 3 | 4 | 4 | 2 |

Device #5 is the next to be inserted.

| Device | Slot | max | |
|---|---|---|---|
| # | duration | (t_{off,n}) | t_{off,n} |
| 4 | 2 | 3 | 0 |
| 3 | 4 | 4 | 2 |
| 5 | 12 | 5 | 6 |

As, for device #5, t_{off,n} is greater than max(t_{off,n}), then new entry #5 is to be moved up, as shown below:

| Device | Slot | max | | |
|---|---|---|---|---|
| # | duration | (t_{off,n}) | t_{off,n} | |
| 4 | 2 | 3 | 0 | |
| 5 | 2 | 5 | 2 | [symbol] |
| 3 | 4 | 4 | 4 | |

and t_{off,n} are re-calculated for both devices #5 and #3.

Referring again to FIG. 4, step S5 is repeated and the considered device is placed upper in the list L1 until its time offset t_{off,n} becomes higher or equal to its maximum supported time offset Max(t_{off,n}). Then, the thus modified list (becoming list L2) is stored in a memory in step S6. The next “considered device” (at the head of the list) is picked again in step S3 and put at the end of the list. The process is performed again until all the “considered devices” of the list (at its head) could have been placed at a correct position of the list in step S5. This is the aim of test S7, which is performed with an incrementing of a device index j until j=n, with n the number of devices in set S, (i.e. devices for which a timeslot is allocated in the next super-frame).

Then, in step S12, the beacon can be broadcast, according to the data contented in list L2 with finally:
The order of the devices to be allocated with a timeslot within the super-frame following the beacon defined in step S12, and especially
The time offset these devices should wait for before having their dedicated timeslot.

In a particular optional embodiment described hereafter and drawn in dashed lines in FIG. 4, energy bursts can be provided to load the devices batteries and energy burst scheduling can be implemented by the cell controller further to the method described above with reference to FIG. 4. In some cases indeed, it may not be possible to satisfy requests for timeslots of every device, and some energy bursts should be scheduled to increase the level of energy before the beginning of the super-frame in order to increase the energy E₀ value of some wireless devices.

Consequently, in that optional embodiment, it is proposed to modify the super-frame building algorithm in order to determine the minimum level of additional energy that shall be scheduled in order to fulfil the requirements of every wireless device.

The maximum energy that can be scheduled inside the super-frame n is equal to P_{s,Tx}*Tₛ where Pₛ is the transmitted power of the energy burst, and Tₛ the burst duration.

The received power in device n is equal to P_{s,Rx}=P_{s,Tx}*G_{s,n}*C_{s,n} with G the gain and C the power conversion efficiency ratio. Consequently, the received energy of device n is equal to:

E_{s,n}(tₛ)=tₛ*P_{s,Tx}*G_{s,n}*C_{s,n} with tₛ<Tₛ

The algorithm exposed in FIG. 4 can be slightly modified and enhanced in order to determine further the minimum level of additional energy that shall be scheduled.

Therefore, referring again to FIG. 4, when a classification list has been established in step S6, the missing energy E_{miss,n} is evaluated so as to insert a device #n in an allocation table corresponding to an optimized classification list, with:

E_{miss,n}=[t_{off,n}−max(t_{off,n})·]*P_{A}

It can be calculated then the minimum burst length to insert timeslot of device #n at the given position in the super-frame:

tₛ[t_{off,n}−max(t_{off,n})]*P_{A}/(P_{s,Tx}*G_{s,n}*C_{s,n})

If that value is lower than Tₛ (i.e. the maximum duration of energy burst), then the timeslot is inserted in the allocation table.

Then, in order to minimize the energy burst duration, the lowest tₛ value is selected among the different insertion possibilities, as presented in the examples below.

Here, starting from the same example table below, a timeslot for device #5 is to be added at the end of the table.

| Device | Slot | max | |
|---|---|---|---|
| # | duration | (t_{off,n}) | t_{off,n} |
| 4 | 2 | 3 | 0 |
| 3 | 4 | 4 | 2 |

Unfortunately, its time offset is greater than the maximum supported value. The duration of the requested energy burst to provide the missing energy is equal to 10 ms for example.

| | | | | Requested |
|---|---|---|---|---|
| Device | Slot | max | | duration of |
| # | duration | (t_{off,n}) | t_{off,n} | energy burst |
| 4 | 2 | 3 | 0 | 0 |
| 3 | 4 | 4 | 2 | 0 |
| 5 | 3 | 5 | 6 | 10 |

Trying to move up the entry, the acceptance condition is still not fulfilled because putting timeslot for device #3 at the end implies a time offset greater than the maximum supported value.

However, the duration of the requested energy burst to provide the missing energy is equal to 8 ms, as shown below, which is lower than the previous situation.

| | | | | Requested | |
|---|---|---|---|---|---|
| Device | Slot | max | | duration of | |
| # | duration | (t_{off,n}) | t_{off,n} | energy burst | |
| 4 | 2 | 3 | 0 | 0 | |
| 5 | 3 | 5 | 2 | 0 | [symbol] |
| 3 | 4 | 4 | 5 | 8 | |

Consequently, this solution is applied as allocation table.

Referring then to FIG. 4 again, after step S6 and the definition of an updated list L2, requested duration of energy burst RDEB can be determined for the “considered device” before applying list L2 definitively. More particularly, before moving one “considered device n” up in the list, its requested duration of energy burst RDEB/n is determined is step S7. Furthermore, in step S8, the requested duration of energy burst RDEB/L of the last device #L of the list L2 is also calculated. In step S9, the requested durations of energy burst RDEB/n and RDEB/L are compared and as long as the requested duration of energy burst of the considered device RDEB/n is lower than or equal to the one of the last device in the list RDEB/L, than list L2 can definitely updated, stored in memory in step S6, and the beacon to be broadcast can be based on that list (arrow N from test S9). Otherwise (arrow Y from test S9), the list L2 is not updated and the process goes back to the previous version of list L2 in step S10 (with the previous position of the “considered device”). This non-updated list L2 is stored in memory so as to build the beacon to broadcast on its basis. It should be noted here that the central controller can further schedule then the requested durations of energy burst to provide and calculated thus successively for any “considered device” (or eventually for the last device of the list if step S10 is to be implemented).

The proposed invention can be deployed in IoT communication system for home or office or facilities or factory automation environment. It is compatible with ultra low-powered devices powered by small batteries or energy harvesting system. It can also be advantageously to deploy completely wireless sensors or devices in some specific environment that does not support wires, or to reduce designing/manufacturing/maintenance costs.

In the example shown in FIG. 5, a communication system according to the invention comprises one or several devices D #0, D #1, . . . , D #n, communicating with one cell controller CC according to the invention and comprising a processing circuit configured for performing the method as described above for example with reference to FIG. 4. That processing circuit may comprise for example:
a communication interface COM,
connected to a processor PROC,
and a memory MEM that can store, inter alia, computer program instructions to perform the method when such instructions are read by the processor PROC.

1. A method implemented by a computer for scheduling at least data communication in a system comprising:
communicating devices (D #0, D #1, . . . , D #n), each device having a power battery and being configured for:
awaking in view to receive/transmit data within a predefined timeslot dedicated to said each device, and
then going to a sleep mode so as to save battery power,
and a cell controller (CC) being configured for transmitting repetitively a beacon to the communicating devices to announce to the devices whether future timeslots are intended or not to be allocated to said devices, and eventually moments when said future timeslots are scheduled to be allocated,
wherein each of said devices is further configured for waking up and being active to receive the beacon, and then:
go to a sleep mode if no dedicated timeslot is available for said device before a next beacon, or
in the event when a dedicated timeslot is available for said device before a next beacon:
stay active to use said dedicated timeslot, or
go to a sleep mode until the moment when the dedicated timeslot is to be allocated,
and wherein the cell controller, before sending a current beacon:
a) calculates, for each device intended to have a dedicated timeslot indicated in said current beacon, a maximum time offset Max(t_{off,n}) supported by the device, which takes into account the energy consumption due to go-to-sleep and wake-up phases of the device until the moment when the device can use its dedicated timeslot,
b) ranks and stores in a memory a first list of devices intended to have a dedicated timeslot indicated in the current beacon, according to their maximum supported time offset Max(t_{off,n}), the last device (D #n) of the list having the higher maximum supported time offset Max(t_{off,n}),
c) picks a considered device which is at the head of said first list and inserts it at the end of said first list, and calculates, at least for said considered device, a time offset t_{off,n} between a moment when said current beacon is scheduled to be transmitted and the moment when the timeslot dedicated to the considered device is to be allocated,
d) determines, at least for said considered device, whether the time offset t_{off,n} is greater than the maximum supported time offset Max(t_{off,n}) of the considered device, and if yes:
i. moves said considered device (D #n) upper in the first list,
ii. determines a new time offset t_{off,n} for said considered device, and repeats operation d) until the time offset t_{off,n} is not greater than the maximum supported time offset Max(t_{off,n}) of the considered device,
e) stores in a memory a second list of devices comprising said considered device having a new list position and said new time offset t_{off,n}, and modifies said current beacon according to the second list so as to allocate at least a dedicated timeslot to said considered device at said new time offset t_{off,n}.

2. The method of claim 1, wherein the cell controller:
repeats operations c) and d), the second list of operation d) becoming the first list of operation c), until the second list does not comprise any device for which the time offset t_{off,n} is greater than the maximum supported time offset Max(t_{off,n}),
and updates in operation e) the current beacon according to the second list so as to allocate dedicated timeslots to said devices of the second list at respective updated time offsets t_{off,n}.

3. The method according to claim 1, wherein the maximum supported time offset for a device is given by:
Max(t_{off,n})⁼(E_{0,n}−E_{sf,n}(0))/P_{A}, where:
E_{0,n} is a sensed level of available energy for the device before the start of the beacon broadcast,
E_{sf,n}(0) is an estimated level of consumed energy by the device to:
wake up,
receive the beacon,
receive and/or transmit data during the dedicated timeslot, and
go then to sleep until the next beacon,
and P_{A} is a consumed energy during active phases.

4. The method of claim 3, wherein the estimated level of consumed energy by the device is given by:
E_{sf,n}(0)=P_{Rx}*(T_{Beacon}+T_{Rx,n})+P_{Tx}*T_{Tx,n}+P_{A}*(T_{GS})
Where:
P_{Rx} is the power consumption during the reception phase
P_{Tx} is the power consumption during the transmission phase
T_{Beacon} is the duration of the beacon
T_{Rx,n} is the duration of possible data reception by the device during its dedicated timeslot
T_{Tx,n} is the duration of possible data transmission by the device during its dedicated timeslot
T_{GS} is the time taken by the device to go to sleep and corresponds to a fixed duration.

5. The method of claim 4, wherein a time T_{Dec} taken by the device to decode the beacon is further taken into account and wherein the estimated level of consumed energy by the device is given by:
E_{sf,n}(0)=P_{Rx}*(T_{Beacon}+T_{Rx,n})P_{Tx}*T_{Tx,n}+P_{A}*(T_{Dec}+T_{GS})

6. The method according to claim 4, wherein the cell controller is configured to take into account, at least when allocating a new time offset t_{off,n}, an extra energy cost due to insertion of a sleeping period between the beacon broadcast and the moment when the device receives its dedicated timeslot, said extra energy cost being estimated by:
P_{A}*(T_{GS}+T_{WU}+T_{PreTS}−t_{off,n}) with t_{off,n}<T_{GS}+T_{WU}+T_{PreTS}, and where:
T_{WU} is a time taken by the device to wake up and corresponds to a fixed duration,
T_{PreTS} is an optional time margin taken by the device before starting to use the timeslot and corresponds to a fixed duration.

7. The method according to claim 6, wherein the cell controller is configured to calculate further an estimated energy consumed by the device according to its time offset t_{off,n}:
E_{sf,n}(t_{off,n})=P_{Rx}*(T_{Beacon}±T_{Rx,n})+P_{Tx}*T_{Tx,n}+P_{A}*(T_{Dec}+T_{GS})+P_{A}*min(t_{off,n},T_{GS}+T_{WU}+T_{PreTs})=E_{sf,n}(0)+P_{A}*min(t_{off,n},T_{GS}+T_{WU}+T_{PreTS})
with E_{sf,n}(0)=P_{Rx}*(T_{Beacon}+T_{Rx,n})+P_{Tx}*T_{Tx,n} P_{A}*(T_{Dec}+T_{GS})

8. The method according to claim 1, wherein the cell controller is configured further to schedule energy burst transmissions to devices needing an energy battery load, and wherein the cell controller:
* performs for said considered device of operation d):
a calculation of a first requested duration of energy burst so that the considered device (D #n) is able to use the timeslot scheduled at time offset t_{off,n}, and
a determination of whether the time offset t_{off,n} is greater than the maximum supported time offset Max(t_{off,n}) of the considered device, and if yes, moving said considered device (D #n) upper in the first list, and determining a new time offset t_{off,n} for said considered device, and storing in a memory the second list of devices comprising said considered device having a new list position and said new time offset t_{off,n},
*performs for the last device of the second list:
a calculation of a second requested duration of energy burst so that said last device is able to use a timeslot scheduled at a time offset defined according to the second list,
* and:
if the first requested duration of energy burst is higher than or equal to the second requested duration of energy burst, updates the current beacon according to the second list,
or uses the first list otherwise.

9. The method of claim 8, wherein the cell controller further updates the scheduled duration of energy burst to fit the power need of:
the considered device if the first list is used, or
the last device if the second list is used.

10. A cell controller comprising a processing circuit for performing the method as claimed in claim 1.

11. A non-transitory computer readable medium storing a computer program comprising instructions for performing the method as claimed in claim 1, when such instructions are run by a processor.
